(19) United States
(12) Patent Application Publication
(10) Pub. No.: US 2014/0202732 A1
(43) Pub. Date: Jul. 24, 2014

(54) POWER CABLE DESIGN

(71) Applicant: Alfred MENDELSOHN, Brooklyn, NY (US)

(72) Inventor: Alfred MENDELSOHN, Brooklyn, NY (US)

(21) Appl. No.: 13/748,100

(22) Filed: Jan. 23, 2013

(51) Int. Cl. H01B 7/02; H01B 13/24

(52) U.S. Cl. CPC H01B 7/0216; H01B 13/24
USPC 174/120 SR; 264/171.18

(57) ABSTRACT

The present invention is an improved power cable construction.

Through the use of a multi-ply insulation layer, the resulting power cable retains the water tree or electrical tree resistance of generally-used tree-retardant power cables even though a conventional polymer insulation composition substantially replaces the tree-retardant polymer composition. An improved process that takes advantages of the multi-ply system is also taught.

### FIELD OF THE INVENTION

This invention relates to power cable designs for medium and high voltage applications. In particular, it relates to the insulation layer of such power cable designs and the layer's use for the prevention or retardation of water trees.

### DESCRIPTION OF RELATED ART

The most common cable design for medium voltage power cables uses several layers over a metal conductor (110). See FIG. 1. These layers include an inner semiconductive shield layer (120), an insulation layer (130), an outer semiconductive shield layer (140), a metalic neutral layer (150), and an outer jacket (160). Over the years, these cables have undergone several iterations to provide improved performance, address aging-related failures, and lower costs.

Since the 1940s, power cable designs have incorporated polyethylene and later crosslinked polyethylene (XLPE) as polymeric materials in the insulation layer of medium voltage cables operating in wet and dry environments on underground electric utility systems. Low and high voltage power cable designs have also used these polymeric materials in their insulation layers.

A filled elastomeric insulation has been used as an alternative to thermoplastic polyethylene insulation. The polymer component of the filled elastomeric insulation is typically ethylene propylene copolymer or ethylene propylene diene terpolymer. Generically, these filled elastomeric insulations are referred to as “EPR” insulation. When compared to unfilled XLPE insulation, an EPR insulation provides improved high temperature deformation resistance and increased flexibility.

The performance of XLPE and EPR insulated cables was generally satisfactory until the 1970s when the degradation process of water treeing was discovered. These water trees initiate and propagate over a period of years and eventually render the dielectric unable to sustain the applied voltage, resulting in premature cable failures.

A “water tree” is defined as a diffuse structure in a dielectric insulating material with an appearance resembling a bush or a fan. (E. F. Steennis and F. H. Kreuger, “Water Treeing in Polyethylene Cables,” IEEE Transactions on Electrical Insulation, Vol. 25, No. 5, p. 989 (October 1990). It is believed that physical or chemical contamination or defects in the insulation or at the inner semiconductive shield layer surface, in the presence of moisture and a stress enhancement of the electrical field causes water treeing.

There are two types of water trees: (1) vented water trees and (2) bow-tie water trees. “Vented water trees” initiate from the surface of the semiconductive shield layers and grow into the insulation layer. “Bow-tie trees” grow from defects inside the insulation layer and in both directions aligned with the electric field. It is believed that the most detrimental water trees are vented water trees that grow from the inner semiconductive shield layer, which is the area of greatest electrical stress.

While this mechanism of water treeing is common to both XLPE and EPR insulations, it was believed that EPR insulations would have improved resistance to water treeing.

In response to the water treeing problems, most research in the late 1970s was directed toward developing improved cable insulation materials, cable designs, and cable manufacturing technology. It was also hoped that improved resistance to water treeing would also improve resistance to degradation of electrical strength with aging and contribute to a longer service life for XLPE and EPR cables.

For XLPE insulation applications, tree retardant XLPE materials were developed and generically referred to as TR-XLPE. Two predominant approaches for TR-XLPE have been used: (1) the use of a polyethylene glycol (“PEG”) additive (U.S. Pat. No. 4,440,671 and U.S. Pat. No. 6,869,995) and (2) the use of a polar ethylene alkyl copolymer as an additive (EP 0179845). The approach incorporating the PEG additive was been referred to as additive TR-XLPE. The other approach is commonly referred to as copolymer TR-XLPE.

Both approaches have provided high resistance to the initiation and the growth of water trees, yielding improved electric strength for power cable with aging in moist environments. As such and since the 1980s, North American utility companies have specified TR-XLPE formulations for the insulation layer for virtually all underground XLPE medium voltage power cables, instead of XLPE.

In that same vein, the Insulated Conductors Committee Discussion Group A4D, an industry committee, has worked on defining TR-XLPE performance and determined that after subjecting TR-XLPE insulated cables to the Accelerated Water Treeing Test (AWTT) for 1 or 2 years of accelerated aging, the resulting vented water trees were typically shorter than 10 mils (0.25 mm). In conventional XLPE cables, the length of vented water trees were significantly in excess of 20 mils (0.5 mm).

As such, the committee has recommended that vented water tree length be less than 20 mils after accelerated aging. See S. Pelissou, et al., “A Review of Possible Methods for Defining Tree Retardant Crosslinked Polyethylene (TRXLPE),” IEEE Electrical Insulation Magazine, Vol. 24, No. 5, pp. 22-30 (September 2008).

Currently, the insulation layer is generally made from a fully-formulated TR-XLPE compound which contains or is prepared using a tree retardant additive, antioxidants, other functional additives such as cure boosters, and an organic peroxide as the chemical crosslinking agent.

With regard to improved cable designs, research and development efforts have yielded improvements of using (i) blocked stranded conductors or solid conductors to prevent longitudinal transport of moisture in the conductor of the cable, (ii) water-swellable tapes over the cable core, and (iii) corrugated longitudinally sealed copper tubes as the neutral to resist radial transport of moisture in the cable. None of these design improvements has focused on addressing the problem of water-treeing (a) at the interface between the inner semiconductive shield layer and the insulation layer or (b) in the insulation layer itself.

With regard to improvements in cable manufacturing, the power cable manufacturers turned to the use of three extruders to form an extruded cable core, wherein the inner semiconductive shield layer (210), the insulation layer (220), and the outer semiconductive shield layer (230) were coextruded simultaneously over the metal conductor (240), which is pulled through the triple-crosshead die (250). See FIG. 2. The extruded cable core was then immediately passed through a continuous vulcanization (CV) tube (260) under pressurized nitrogen. The heated CV tube exposed the cable core to very high temperatures, thereby causing the three cable layers to crosslink. Next, the cable core passed through a cooling tube (270) to cool the cable core sufficiently for coiling the cable core on reels (280) without deformation. In subsequent steps, the neutral layer and the outer jacket were applied over the cable core to yield the finished power cable.

With the improved extrusion process, cable manufacturers were able to produce smoother interfaces between the semiconductive shield layers and the insulation, thereby minimizing physical stress enhancement points at those interfaces.

However, the extrusion process has significant challenges. Cable manufacturers learned that operating extruders to process the crosslinkable compounds used in cable core under the same conditions the manufacturers had used to process compounds not containing chemical crosslinking agents, would detrimentally affect the quality of the resulting cable. Notably, premature crosslinking would occur in the extruders, prior to the molten polymer layers exiting the triple crosshead, and create hard, partially-crosslinked particles (i.e., “scorch” particles). These scorch particles were defects in the insulation layer of the cable and could act as sources of water treeing or other causes of cable failure.

To produce quality cable cores free of scorch particles in the CV extrusion process, cable manufacturers had to avoid premature crosslinking in the extruder and accordingly, chose to limit the maximum operating extrusion temperature in response to the threat. However, the manufacturers then incurred the cost of cutting their output rates to almost half that of extruding the same materials without peroxide.

It is desirable to overcome the maximum temperature limitation, thereby affecting productivity rates and costs.

Cable manufacturers have unsuccessfully turned to (a) moisture cure (or “silane” cure) technology to overcome the maximum temperature limitation and (b) direct peroxide injection (“DPI”) technology to reduce raw material costs. The resulting cables lacked the performance of CV-cured TR-XLPE cables.

Silane curing takes place in the solid state, after cable extrusion, by exposing the cable insulation to moisture and elevated temperature in the range of 70-90 degrees Celsius. Essentially, the steps of extrusion and crosslinking are decoupled. While the decoupling allows the cable extrusion to occur at higher rates, moisture-cured cables are yet to match the performance of CV-cured TR-XLPE cables.

Direct peroxide injection (DPI), which focuses primarily on raw material cost reduction, keeps the chemical peroxide crosslinking process and its inherent extrusion rate limitation, but uses lower price polyethylene base resin for the insulation and introduces the peroxide and antioxidant additive directly into the extruder. This approach has been practiced by some European cable manufacturers since the 1990's. It was also attempted with limited success by manufacturers in less developed countries.

With regard to DPI, the organic peroxide chemical crosslinking agent is directly injected into the extruder. A significant advance to the DPI process, introduced by LICO Spa, involves a precision feeding system and an inline premixer. The base polymer, the crosslinking agent, and the other additives in liquid form are premixed. Unfortunately, polyethylene glycol for additive TR-XLPE compounds does not premix effectively into the compound. Similarly, the copolymer for copolymer TR-XLPE compounds does not distribute well at the microscale level. Accordingly, effective performance has proven elusive.

Without an aim to overcoming water-treeing, others have sought to achieve improved properties with a multi-ply insulation layer for other purposes.

For example, U.S. Pat. No. 3,792,192 discloses a two-ply insulation layer for providing improved corona discharge. The disclosed cable construction uses an inner layer of EPR insulation such as ethylene-propylene copolymer or ethylene-propylene-diene terpolymer and an outer layer of XLPE insulation. The EPR layer provides corona resistance on the inside of the insulation, where the electrical stresses have their highest values and the conductor generates high temperatures.

M. M. A. Salama, et al., “Instructional Design of Multi-Layer Insulation of Power Cables,” Transactions on Power Systems, Vol. 7, No. 1, pp. 377-82 (February 1992) discloses a tutorial design procedure for a multi-layer insulation of an electrical power voltage distribution cable to satisfy the engineering requirements of a maximum insulation utilization, a maximum load current, and a minimum outside diameter of the cable. The inner layer is an expensive, higher electrical field strength material while the outer layer is a less expensive, lower electrical field strength material.

U.S. Pat. No. 5,575,965 discloses a two-ply insulation layer where the inner layer is a homogeneous polyethylene formulation, having improved melt-fracture characteristics when compared to a single layer insulation based on homogeneous polyethylene. Homogeneous polyethylene-based compositions are known to experience a phenomenon described as melt fracture in which, upon exiting the extruder die, the extrudate has a highly irregular, rough surface.

To ovecome the melt-facture problem, the inner layer based on a homogeneous polyethylene formulation had a thickness generally in the range of about 30 to about 200 mils. The outer layer became a formulation containing one of three different polymers: (i) a copolymer of ethylene and an unsaturated ester; (ii) a high pressure polyethylene; or (iii) a very low density polyethylene. The outer layer was generally at least about 5 mils in thickness, with the upper limit being a matter of economics and application.

In a similar fashion, WO 99/44206 A1 discloses an insulation layer having inner and outer polar-enriched surface zones for use in a high-voltage, direct current cable. The use of the insulation layer is believed to decrease the mobility of space charges, reduce space charge accumulation, increase the capability to withstand charge injection, and control any developing space charge profile or pattern. The published application does not clearly indicate how the polar-enriched surface zones are achieved, whether through a multi-ply process or some other process. In any event, the polar-enriched surface zones were not employed to combat water trees.

### SUMMARY OF THE INVENTION

The present invention is a power cable construction having a metal conductor and an multi-ply insulation layer, among other layers, over the metal conductor. The multi-ply insulation layer has at least two plys, wherein the first, inner tree-retardant ply is made from or contains a tree-retardant polymer compostion and the second, outer ply is made from or contains a conventional polymeric insulation composition.

The present invention provides improved insulative properties for power cables and opportunities for processing and costs improvements. These improvements may be realized through composition, design, or manufacturing choices disclosed herein.

### DESCRIPTION OF THE DRAWINGS

Further details will be apparent from the following detailed description, with reference to the enclosed drawing, in which:

FIG. 1 is a perspective view of an electrical cable according to a typical medium voltage cable design.

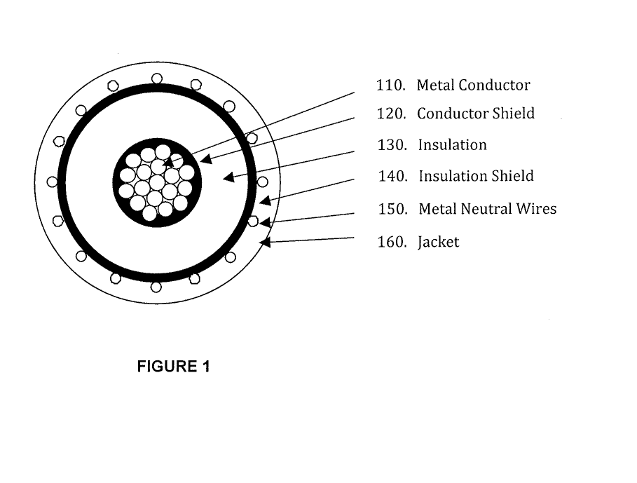

FIG. 2 is a schematic of a typical continuous vulcanization extrusion process for preparing a cable core of a typical medium voltage cable.

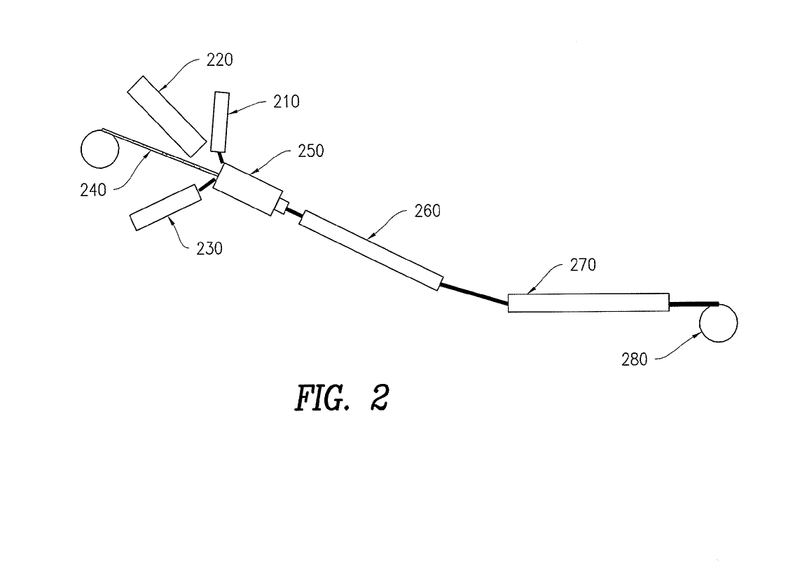

FIG. 3 is a perspective view of an electrical cable according to the presently-invented voltage cable design.

### DETAILED DESCRIPTION

In a first embodiment, the present invention is a power cable construction having a metal conductor and an multi-ply insulation layer, among other layers, over the metal conductor. The multi-ply insulation layer has at least two plys, wherein the first, inner tree-retardant ply is made from or contains a tree-retardant polymer compostion and the second, outer ply is made from or contains a conventional polymeric insulation composition.

For example, the multi-ply insulation layer may use a TR-XLPE composition as the composition for making the first, inner tree-retardant ply and a conventional XLPE composition for making the second, outer ply. As another example, the multi-ply insulation may use a tree retardant EPR as the composition for making the first, inner tree-retardant ply and a conventional EPR composition for making the second, outer ply. Notably, when the first, inner tree-retardant ply is a tree retardant EPR, suitable outer layers include, for example, unfilled or lightly filled elastomers. Certainly, a person of ordinary skill in the art can envision combinations of tree-retardant inner plies and conventional insulation outer plies, within the scope of this invention.

Examples of tree-retardant insulation compositions are taught in U.S. Pat. Nos. 4,440,671, 6,828,505, 6,869,995, and 7,968,623, U.S. Patent Application Publication No. 2011/0094772 A1, and European Patent No. 0 179 845 B1. The disclosure of these documents is incorporated herein.

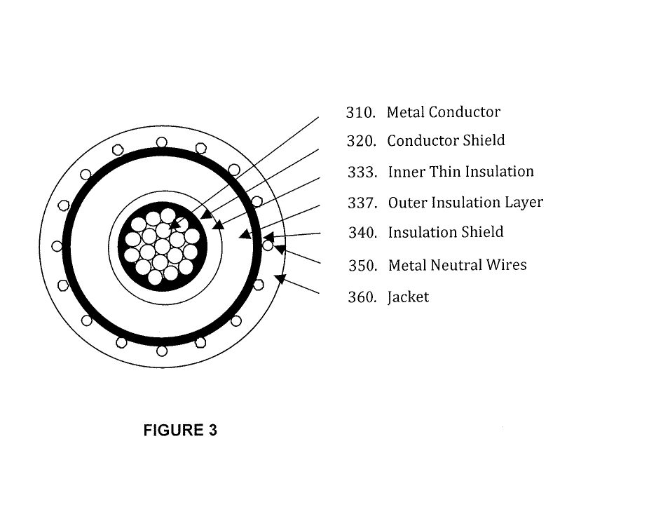

Accordingly and considering the most common cable design for medium voltage power cables, the use of the described multi-ply insulation layer would contain (a) a metal conductor (310), (b) an inner semiconductive shield layer (320), (c) a multi-ply insulation layer (330) having an (i) first, inner TR-XLPE ply (333) and (ii) a second, outer XLPE ply (337), (d) an outer semiconductive shield layer (340), (e) a neutral layer (350), and (f) an outer jacket (360). See FIG. 3.

In view of the Insulated Conductors Committee Discussion Group A4D's observation that vented water trees were typically shorter than 10 mils (0.25 mm) after subjecting TR-XLPE insulated cables to accelerated aging, the present invention contemplates that the thickness of the first, inner tree-retardant ply of the multi-ply insulation layer should be sufficient to encompass a 10-mil vented water tree. As such, the thickness of the first, inner tree-retardant ply can be less than about 50 miles, preferably less than about 30 mils, more preferably less than about 25 mils, and most preferably less than about 20 mils.

Depending upon the cable design, the second, outer ply of the insulation layer can be in the range of about 175 mils to about 345 mils for most medium voltage constructions. It is contemplated that other power cable applications may require smaller or larger thicknesses of the second, outer ply.

It is noted that a person of ordinary skill in the art would readily recognize that the present invention can be applied to high voltage cables applications. For examples, those persons of ordinary skill would readily comprehend that ultra clean XLPE insulation compounds may be used with the present invention.

It is known that water treeing is generally not a concern for high voltage cables because these cables typically have a metal outer layer to prevent moisture from entering the cable insulation. However, the use of the present invention may be employed to prevent electrical treeing in high voltage cables. To that end, a tree-retardant polymer composition may be used as a first, inner ply to prevent electrical treeing at the source of the greatest electrical stress on high voltage power cables, by incorporating electrical tree retardant additives into the insulating polymer composition.

In a second embodiment, the present invention is a process for making a power cable construction having a metal conductor and an multi-ply insulation layer, among other layers, over the metal conductor. The multi-ply insulation layer has at least two plys, wherein the first, inner tree-retardant ply is made from or contains a tree-retardant polymer compostion and the second, outer ply is made from or contains a conventional polymeric insulation composition.

The first, inner tree-retardant ply is made using conventional premixing techniques to prepare a crosslinkable, TR-XLPE composition for co-extrusion through a multi-crosshead extruder, typically a quadruple-crosshead extruder. The second, outer ply may be prepared inline using direct peroxide injection technology with a polyethylene base resin. Optimally, a premixer is utilized in the DPI process to add and disperse the chemical crosslinking agent and other components into the polyethylene base resin inline, prior to extrusion.

In view of the teaching of U.S. Patent Application Publication No. 2011/0094772 A1, it is further contemplated that for the first, inner tree-retardant ply, a compounded TR-XLPE formulation without the peroxide may be supplied to the extruder and the peroxide may be added using the DPI approach.

In this embodiment, a quadruple-crosshead extruder forms an extruded cable core, having (i) an inner semiconductive shield layer, (ii) a multi-ply insulation layer with (a) a first, inner tree-retardant ply and (b) a second, outer conventional ply, and (iii) an outer semiconductive shield layer coextruded simultaneously over a metal conductor, which is pulled through the quadruple-crosshead die.

Although the invention has been described in considerable detail by the preceding specification, this detail is for the purpose of illustration and is not to be construed as a limitation upon the following appended claims. All cited reports, references, U.S. patents, allowed U.S. patent applications, and U.S. Patent Applications Publications are incorporated herein by reference.

What is claimed:

1. A power cable construction comprising:
(a) a metal conductor and
(b) a multi-ply insulation layer having
(i) a first, inner tree-retardant ply made from or containing a tree-retardant polymer composition and
(ii) a second, outer ply made from or containing an insulating polymer composition.

2. The power cable construction of claim 1 wherein the tree-retardant polymer composition is a TR-XLPE composition and the insulating polymer composition is an XLPE composition.

3. The power cable construction of claim 1 wherein the tree-retardant polymer composition is a tree-retardant EPR composition and the insulating polymer composition is an EPR composition.

4. The power cable construction of claim 1 wherein the thickness of the first, inner tree-retardant ply is less than about 50 mils.

5. The power cable construction of claim 1 wherein the tree-retardant polymer composition comprises an insulating polymer and an electrical tree retardant.

6. A process for making a power cable construction comprising the step of extruding a multi-ply insulation layer over a metal conductor using a separate extruder for each ply of the insulation layer, wherein the multi-ply insulation layer has (i) a first, inner tree-retardant ply made from or containing a tree-retardant polymer composition and (ii) a second, outer ply made from or containing an insulating polymer composition.

7. The process of claim 6 wherein the insulating polymer composition is an XLPE and further comprises the step of using direct peroxide injection to add the peroxide chemical crosslinking agent to the polyethylene base resin.

8. The process of claim 6 wherein the insulating polymer composition is an XLPE and further comprises the step of using a premixer to add and disperse the chemical crosslinking agent and, optionally other additives, into to the polyethylene base resin prior to extrusion.
